(19) United States
(12) Patent Application Publication
(10) Pub. No.: US 2025/0294371 A1
(43) Pub. Date: Sep. 18, 2025

(54) TROPOSPHERIC DUCTING PREDICTION AND MITIGATION

(71) Applicant: T-Mobile USA, Inc., Bellevue, WA (US)

(72) Inventors: Roopesh Kumar Polaganga, Bothell, WA (US); Robert Berrier, Renton, WA (US); Baidar Yacoub Oweis, Kenmore, WA (US); Maher Hasan, Ashburn, VA (US); Justin Mueller, Sammamish, WA (US); Kurt Landuyt, Parkville, MO (US); Gopal Sood, Plano, TX (US); Muhammad Shakil, Snoqualmie, WA (US); Moazzem Hossain, Frisco, TX (US)

(21) Appl. No.: 18/605,626

(22) Filed: Mar. 14, 2024

(51) Int. Cl. H04W 16/28; H04W 24/02

(52) U.S. Cl. CPC H04W 16/28; H04W 24/02

(57) ABSTRACT

A method can include receiving atmospheric data comprising atmospheric parameters. A method can include receiving current cell site configuration data of one or more cell sites of a wireless telecommunications network. A method can include applying a machine learning model to the atmospheric data and the current cell site configuration data to predict a tropospheric ducting event, wherein the model is trained using supervised learning performed using historical atmospheric and cell site configuration data as inputs and historical tropospheric ducting events as outputs. A method can include determining a likelihood of a tropospheric ducting event affecting a cell site among the one or more cell sites in a geographic area. A method can include determining a mitigation action to perform at the cell site, wherein implementing the mitigation action at the cell site effectuates reduction in an impact of the predicted tropospheric ducting event at the cell site.

### BACKGROUND

Tropospheric propagation is the propagation of electromagnetic waves in the troposphere, the lowest layer of earth's atmosphere, extending from the surface of earth up to about 6 km to 18 km from the surface, depending upon latitude, season, and other factors. Under typical conditions, radio signals may travel a limited distance before becoming too attenuated to present a significant interference problem. For example, radio signals may not propagate significantly beyond the horizon. In some cases, some radio signals can be blocked by obstructions in the line of sight between the radio source and a receiver.

Tropospheric ducting can enable radio signals to travel longer distances than would be observed under normal/typical conditions. Tropospheric ducting tends to occur during periods of stable, anticyclonic (e.g., high pressure) weather. When a signal encounters a rise in temperature in the atmosphere as it propagates to greater elevations, rather than the typical decrease in temperature with increasing elevation (temperature inversion), differences in the refractive index in the atmosphere can cause the signal to be bent. During tropospheric ducting events, signals can travel significantly longer than usual, for example 1000 km or more in some cases, although tropospheric ducts can be smaller.

Tropospheric ducting can be more or less common depending on location, season, and so forth. For example, during summer and autumn months, tropospheric ducting can be more common. Temperature inversions can occur more frequently in coastal areas and near large bodies of water, resulting from the onshore movement of cool, humid air around sunset as the ground cools more quickly than the upper air layers. Tropospheric ducting can also occur around sunrise, as upper layers are warmed more quickly than those closer to the ground.

Tropospheric ducting can pose significant problems for radio communications. For example, interference can occur between radio signals, while such interference may not occur during ordinary conditions due to the separation between transmission sources.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an example of tropospheric ducting.

FIG. 4 illustrates an example of remote interference.

FIG. 5 shows an example frame and associated remote interference.

FIG. 6 is a block diagram that illustrates an example of training and using a machine learning model to predict remote interference.

FIG. 7 is a block diagram that illustrates an example process for predicting tropospheric ducting events and determining mitigations.

FIG. 8 is a block diagram that illustrates an example process for training a machine learning model.

FIG. 9 illustrates an example process for defining geographic areas and trimming data.

FIG. 10 illustrates an example user interface that can be used to display tropoducting information.

FIG. 11 illustrates another example user interface that can be used to display tropoducting information.

FIG. 12 illustrates another example user interface that can used to check the deployment status of features at cell sites according to some implementations.

FIG. 13 shows an example plot of total daily tropoducting.

FIG. 14 shows an example plot of daily occurrence of tropoducting.

FIG. 15 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

As will be explained in more detail herein, various implementations can be used to predict tropospheric ducting and/or to predict remote interference between cell sites. In some implementations, a machine learning model can be used to predict tropospheric ducting events between cell sites in a wireless telecommunications network.

Time division duplexing (TDD) can be used to divide available radio resources between downlink and uplink. In some cases, downlink signals, which typically have much higher transmit power than uplink signals, can interfere with uplink signals. TDD can use a guard period when switching between downlink and uplink. The guard period can be a period of time with no downlink or uplink transmission.

In some cases, the guard period may not be sufficient to prevent interference between downlink and uplink signals. For example, distant cell sites (e.g., separated by hundreds or even thousands of kilometers) may not interfere with one another during most weather conditions. However, in some cases, tropospheric ducts can act as waveguides that allow radio transmissions to travel large distances with relatively little signal attenuation. A distant signal has a propagation delay, which may be long enough that the downlink signal from an aggressor base station can interfere with an uplink signal of a victim base station.

Tropospheric ducting can present significant problems for wireless communications. For example, tropospheric ducting can result in remote interference between distantly-located cell sites that can result in call disruption, data transmission disruption, and so forth. Current approaches can be reactive. For example, key performance indicators (KPIs) or other telemetry data can be used to detect tropospheric ducting once it begins, but such a reactive approach can result in poor customer experience, as mitigations are only undertaken after problems have become apparent. Additionally, the mitigations that can be undertaken can be limited, as certain changes can require equipment restarts or other actions that cannot be performed while equipment is active. Tropospheric ducting can be especially problematic in modern wireless networks, for example those operating at around 2.5 GHZ, although tropospheric ducting can affect other frequencies as well.

To some degree, a network can be designed to be resistant to tropospheric ducting. For example, the guard period between uplink and downlink can be increased to cover propagation delay associated with remote interference. In some cases, a network operator can increase the downtilt of a base station antenna so that less power is directed into a tropospheric duct. However, these mitigations can present significant issues. For example, if the guard period is increased, the capacity of the base station can decrease. If the downtilt is increased, the coverage area of the base station can be decreased.

Some tropoducting mitigation steps, such as adjusting downtilt, can have significant impacts on greenhouse gas emissions, as downtilt adjustments can require a crew or technician to travel to a cell site location to manually adjust an antenna's downtilt. If technicians are dispatched in advance of whether events without reliable predictions of whether or not tropoducting will occur, greenhouse gas emissions can be needlessly produced as technicians can travel to locations that are unlikely to actually experience tropoducting. If adjustments are made in a reactive manner, technicians can be dispatched at irregular times, which can result in increased greenhouse gas emissions as technicians drive poorly optimized or otherwise inefficient routes to address issues as they arise.

Accordingly, there is a need for systems and methods that can be used to predict tropospheric ducting events so that mitigation steps can be taken before the negative effects of tropospheric ducting are seen. In some applications, predictive tropospheric ducting can enable offline mitigations (e.g., those requiring equipment restarts and/or manual adjustments to cellular equipment such as antennas) to be carried out during a maintenance window before an expected tropospheric ducting event.

The approaches described herein can enable a telecommunications company to reduce greenhouse gas emissions by planning mitigation steps in advance and reducing or eliminating needless trips to cell sites, thereby reducing the number of miles driven by a vehicle to perform mitigation steps. For example, trips may not be made to cell sites that are unlikely to experience tropoducting. In some implementations, tropoducting events can be projected hours, days, or even weeks in advance, which can enable the telecommunications company to efficiently plan routes to cell sites, thereby reducing greenhouse gas emissions. In some cases, the approaches herein can enable a telecommunications company to perform mitigation steps during scheduled maintenance windows, thereby avoiding the need for additional trips to cell sites and preventing greenhouse gas emissions associated with additional trips.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

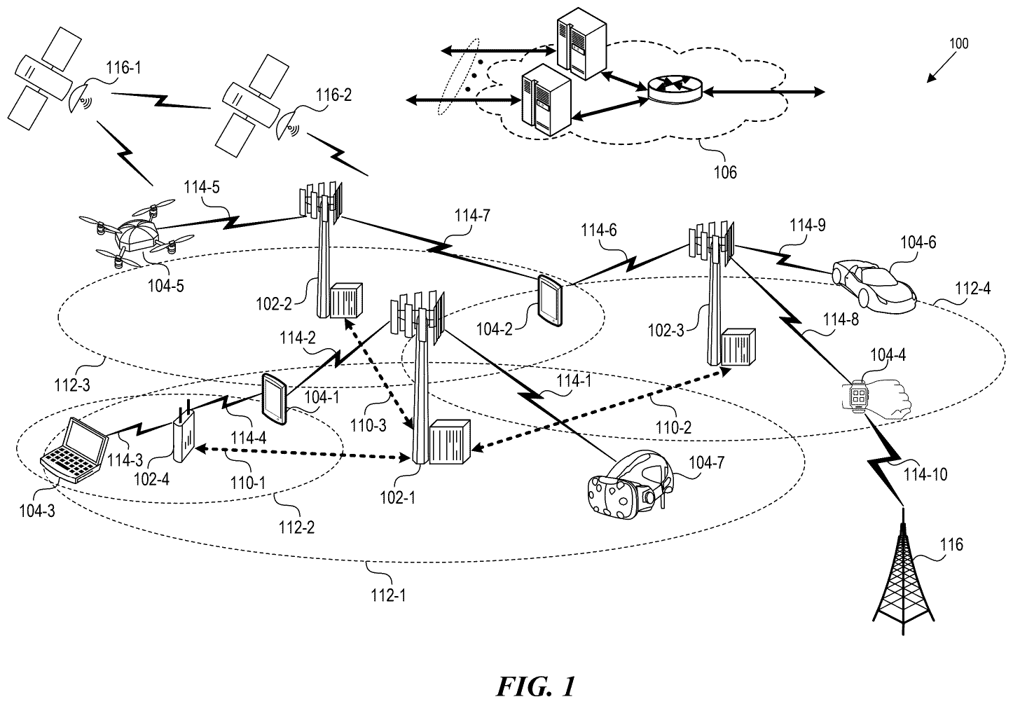

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

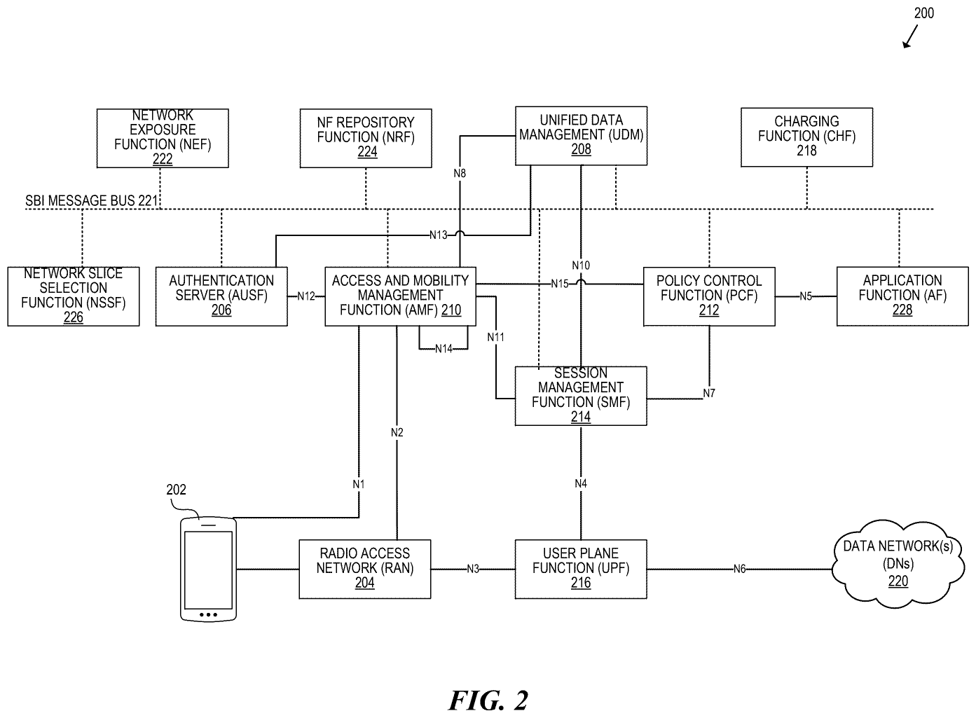

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Tropospheric Ducting Prediction and Mitigation

As described above, tropospheric ducting can present a significant issue for wireless telecommunications networks. Tropospheric ducting can result in degraded network performance or even network outages. In some cases, tropospheric ducting events can be relatively short, lasting for example for from several minutes to a few hours. In some cases, tropospheric ducting events can last for many hours or even days.

Conventionally, responding to tropospheric ducting events is a reactive process, but this can result in negative customer experiences as mitigation actions may not be taken until impacts are already observed. Moreover, certain mitigation actions cannot be performed while a cell site is operational.

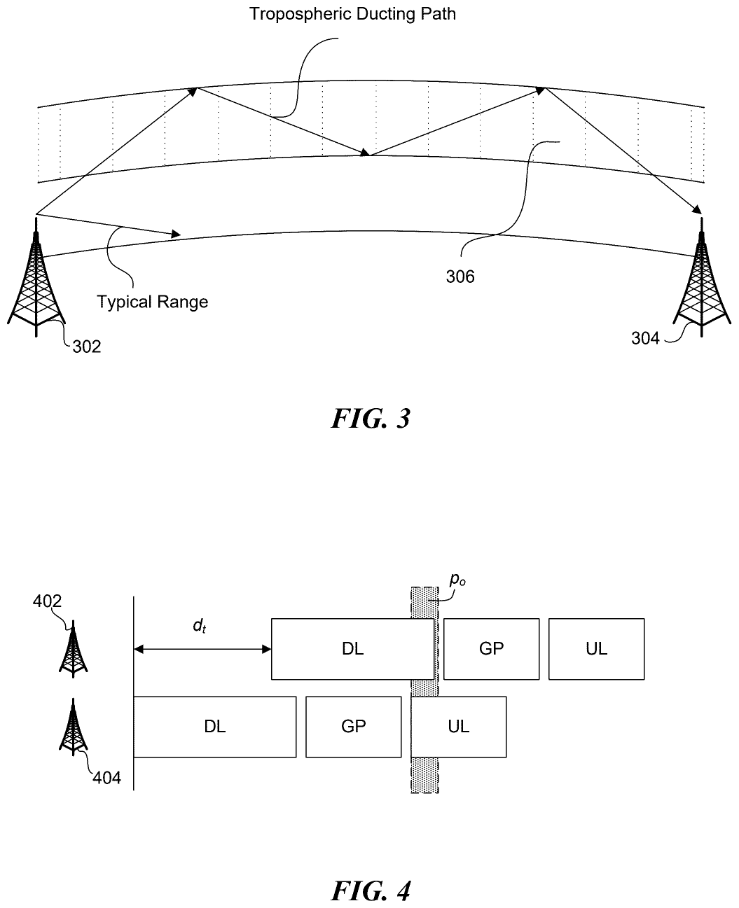

FIG. 3 illustrates an example of tropospheric ducting. In FIG. 3, an aggressor cell site 302 interferes with a victim cell site 304. Under normal conditions, the aggressor cell site 302 can have a typical range that does not extend to the location of the victim cell site 304. However, under certain atmospheric conditions, a tropospheric duct 306 can form. Radio waves can travel through the tropospheric duct 306 along the tropospheric ducting path and reach the victim cell site 304. Typically, though not necessarily, the interfering signal is a downlink signal, which often can be significantly stronger than an uplink signal.

In time division duplexing (TDD) systems, a guard period is commonly used to protect against interference between downlink and uplink signals. However, when signals are received from far away, there can be a significant transmission delay which can exceed the guard period, resulting in interference between downlink and uplink signals.

FIG. 4 illustrates an example of remote interference. Transmission from an aggressor cell site 402 can reach a victim cell site 404 with a time delay dt. The time delay can be sufficient such that the downlink period (DL) of the aggressor cell site 402 extends beyond the guard period (GP) of the victim cell site 404 and into the uplink period (UL). There can be an overlap period po during which the downlink of the aggressor cell site 402 and the uplink of the victim cell site 404 overlap at the location of the victim cell site 404, resulting in remote interference and disruption of the uplink signal of the victim cell site 404.

The 5G new radio (NR) frame structure is defined by the 3GPP. Several different TDD configurations are possible, depending on the usage case. For example, TDD configurations can be optimized for uplink-heavy transmission or downlink-heavy transmission. A frame can be divided into subframes (e.g., 10 subframes), also referred to herein as slots. Each slot can consist of a number of symbols (e.g., 14 symbols).

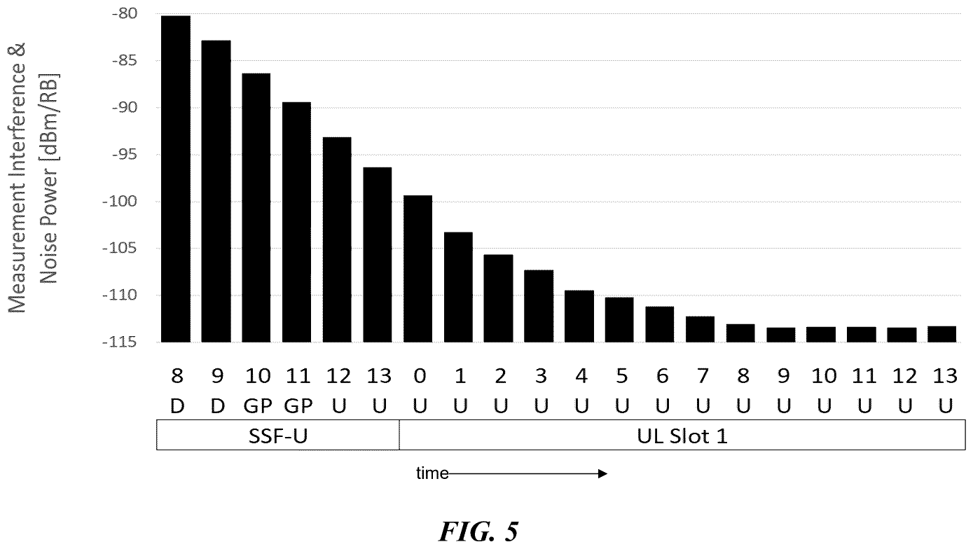

FIG. 5 shows an example frame and associated remote interference. The vertical axis can represent a remote interference strength. As shown in FIG. 5, there can be significant remote interference during symbols 8 and 9, corresponding to a downlink period, slots 10 and 11, corresponding to a guard period, and slots 12 and 13, corresponding to an uplink period of an SSF-U (Special Subframe-Uplink) slot. A UL slot can have significant remote interference during earlier symbols, which can taper off with later symbols. This tapering off is typical of remote interference. Typically, remote interference can be caused by signals from multiple remote cell sites, each having a different propagation delay, which can cause uplink symbols close to the guard period to experience greater remote interference as compared to subsequent symbols. In some implementations, the slope of remote interference over time can be used to determine the presence of a remote interference (tropospheric ducting) event. In some implementations, tropospheric ducting events can be determined based on physical uplink shared channel (PUSCH) received interference power and uplink symbol IpN (interference plus noise) delta.

Accurately predicting tropospheric ducting events can have many benefits for wireless telecommunications operators and for users of wireless telecommunications networks. For example, mitigation actions can be taken before a tropospheric ducting event, which can reduce or eliminate the impacts of tropospheric ducting on a wireless telecommunications network.

However, there are many factors that determine whether tropospheric ducting occurs and if so, whether or not a cell site will be impacted. For example, based on the orientation (e.g., azimuth, tilt, etc.) of an antenna at a cell site, a remote cell site may or may not be likely to interfere with a given cell site. Tropospheric ducting can impact different frequencies differently, for example because the refractive index of air varies with frequency. Conditions in the troposphere can determine whether or not tropospheric ducting is likely or even possible. For example, humidity, air temperature, atmospheric pressure within the troposphere (also referred to as tropospheric pressure), and refractive index can influence whether or not tropospheric ducting occurs.

In some implementations, a machine learning model can be trained to predict tropospheric ducting. In some implementations, the machine learning model can be trained to predict remote interference at a cell site. In some implementations, the machine learning model can be trained to predict a duration of a remote interference event at a cell site.

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine learning model can be a neural network with multiple input nodes that receive atmospheric data, cell site location data, and so forth. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used for predicting tropospheric ducting and/or resulting remote interference events. In some implementations, such neural networks, known as deep neural networks, can have multiple layers of intermediate nodes with different configurations, can be a combination of models that receive different parts of the input and/or input from other parts of the deep neural network, or are convolutions-partially using output from previous iterations of applying the model as further input to produce results for the current input.

A machine learning model can be trained with supervised learning, where the training data includes atmospheric data and cell site location data as input and a desired output, such as the occurrence of remote interference at a cell site. A representation of the input data can be provided to the model. Output from the model can be compared to the desired output for a given input and, based on the comparison, the model can be modified, such as by changing weights between nodes of the neural network or parameters of the functions used at each node in the neural network (e.g., applying a loss function).

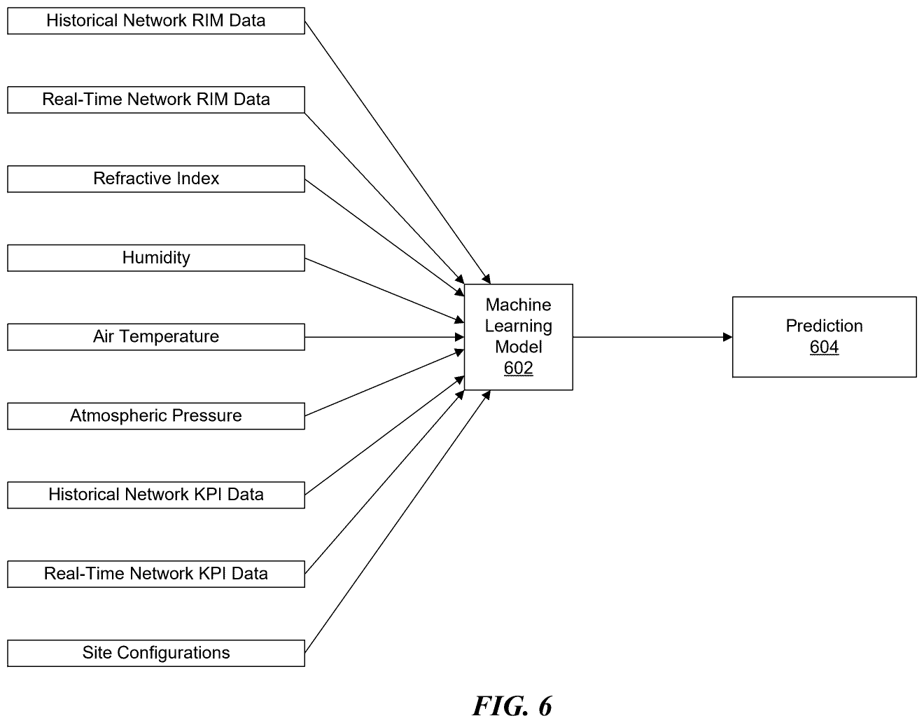

FIG. 6 is a block diagram that illustrates an example of training and using a machine learning model to predict remote interference. A machine learning model can be trained using various inputs. For example, a machine learning model can be trained using historical network remote interference management (RIM) data, historical refractive index data, historical air temperature data, historical humidity data, historical atmospheric pressure data, historic network KPI data, and historical site configuration data. In some implementations, not all of these example data may be used. For example, in some cases, network KPI data may not be used and/or network RIM data may not be used. In some cases, some atmospheric condition data may not be used or can be calculated from other atmospheric condition data. For example, refractive index can be defined as a function of atmospheric pressure, air temperature, and humidity. As these are not necessarily independent variables, in some cases one or more of these parameters can be excluded from model training.

Some examples of KPIs that can be informative for predicting tropospheric ducting events can include, for example and without limitation, average cell downlink throughput, average user equipment downlink throughput, average cell uplink throughput, average user equipment uplink throughput, E-UTRA-NR Dual Connectivity (EN-DC) drop rate (Active and Non-Active), setup success rate (e.g., captured at gNodeB), setup failure rate, NR standalone drop rate, weighted average noise on uplink, weighted average interference power on uplink, downlink PRB utilization, uplink PRB utilization, standalone radio resource control (RRC) connection attempts, physical uplink control channel (PUCCH) signal-to-interference-noise ratio (SINR), NR downlink MAC hybrid automatic repeat request (HARQ) success rate, NR uplink MAC HARQ success rate, NR QAL (NR quality) downlink block error rate (BLER) (also referred to as NR downlink BLER), NR QAL uplink BLER (also referred to as NR uplink BLER), NR MSG3 success rate, NR power PUSCH receive interference power, VoNR (voice over new radio) dropped call rate, radio symbol delta interference plus noise distribution, radio received interference power distribution, radio received interference power in uplink slot distribution (e.g., distributed among different slots, e.g., slots 1 to 6), and/or aggregated absolute power for each PRB. Aggregated absolute power value for each PRB can be represented in units of dBm per PRB. Bins can correspond to individual PRBs. In some implementations, a KPI can be an aggregated count of one or more performance metrics.

After training, the machine learning model 602 can be deployed and used to make a prediction 604. To predict remote interference events, the machine learning model 602 can be provided with current atmospheric conditions (e.g., temperature, humidity, pressure, refractive index), forecast atmospheric conditions, current site configurations, current RIM data, current KPI data, or any combination thereof.

In some implementations, a system can be configured to predict remote interference events. In some implementations, the system can, additionally or alternatively, determine mitigation actions that can be undertaken to reduce or eliminate the effects of tropospheric ducting.

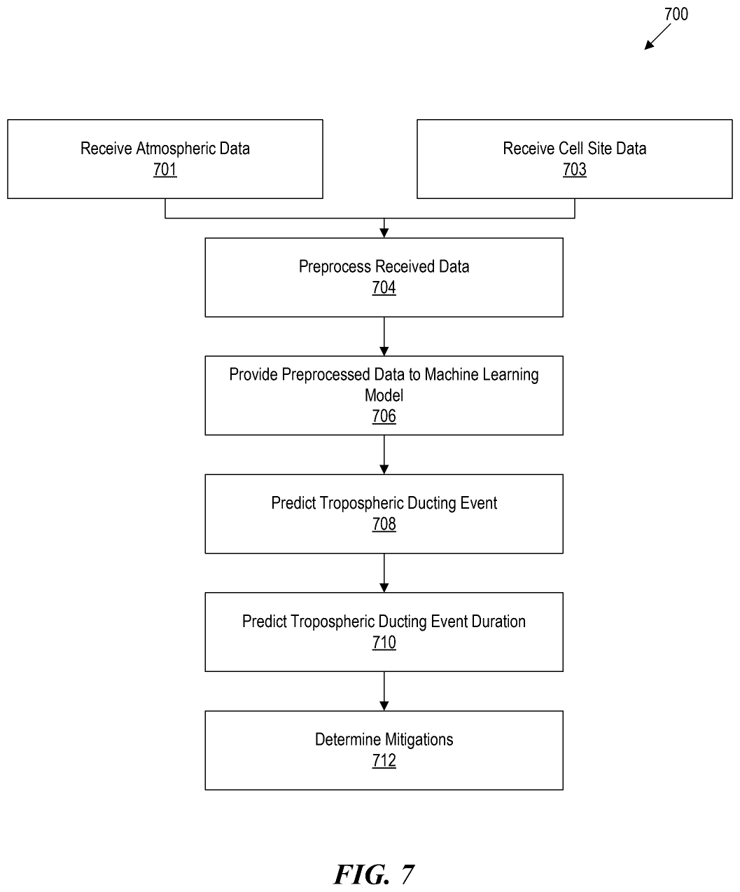

FIG. 7 is a block diagram that illustrates an example process for predicting tropospheric ducting events and determining mitigations. The process 700 can be performed on a computing system. At operation 701, the computing system can receive atmospheric data (e.g., temperature, humidity, pressure, refractive index). In some implementations, the atmospheric data can be current atmospheric data. In some implementations, the atmospheric data can be forecasted atmospheric data. For example, forecasted atmospheric data can be used to predict tropospheric ducting events at future points in time. At operation 703, the computing system can receive cell site configuration data (e.g., current cell site configuration data) and/or other cell site data (e.g., RIM data, KPI data, site configuration data, or any combination thereof). At operation 704, the computing system can preprocess the received data, for example to standardize formats or units, remove undesired information, combine or summarize information, or otherwise prepare the data for feeding into a machine learning model. At operation 706, the computing system can provide the preprocessed data to the machine learning model. At operation 708, the machine learning model can predict a tropospheric ducting event. At operation 710, the computing system can, in an implementation where the machine learning model is trained to predict duration, predict a duration of the tropospheric ducting event. At operation 712, the computing system can determine one or more mitigations that can be performed to mitigate a tropospheric ducting event, such as adjusting power, changing antenna downtilt, adjusting a guard period, changing an uplink power control parameter, forcing handover to a healthy neighbor site, switching an uplink user plane, preventing user equipment from remaining in idle mode on the cell site, MICIS (minimum inter-cell interference scheduling), and so forth. To avoid high inter-cell interference in some parts of the NR frequency band, frequency resource allocations may not be limited to starting from the lower edge of the frequency range. MICIS can be configured to begin frequency resource allocation at different PRB locations.

In some implementations, the process 700 and/or other methods described herein can be implemented in a prediction system. The prediction system can include a data collection module. The data collection module can be configured to receive and/or process data such as atmospheric data, cell site configuration data, and so forth. In some implementations, the prediction system can include a tropospheric ducting prediction module. The tropospheric ducting prediction module can be configured to predict tropospheric ducting events, determine mitigation actions, and/or provide output to a user indicative of the predictions and/or determined mitigation actions.

Various types of machine learning models exist, as do various methods for training machine learning models. In some implementations, a machine learning model can be trained using supervised learning. Supervised learning algorithms can learn from labeled training input features are associated with corresponding target labels or outcomes. Some examples of supervised learning algorithms include, for example and without limitation, linear regression, logistic regression, decision trees, random forests, support vector machines, Naïve Bayes classifiers, and neural networks (e.g., convolutional neural networks, multi-layer perceptron). In some implementations, a logistic regression model can be used. In some implementations, a decision tree model can be used. In some implementations, a random forest model can be used. In some implementations, a convolutional neural network can be used. However, in some implementations, convolutional neural networks may not be preferred because they can involve significantly greater effort and hardware resources to implement than some other models.

Advantageously, the input data for predicting tropospheric ducting events can be relatively simple as compared with other types of data such as images and audio where the use of convolutional neural networks may be indicated. In some implementations, the use of supervised learning can obviate a need to define starting nodes.

In some implementations, models can be selected so that data that is not needed is not included. For example, if a convolutional neural network is used, data for geographic areas that are not of interest (e.g., remote forest or desert regions) can be included as inputs based on a chosen grid resolution, which can slow down performance of the model, increase training time, and so forth.

In some implementations, the machine learning models described herein can be classifier models that determine whether or not a tropospheric ducting event will occur or not for a given instance of time for a given site.

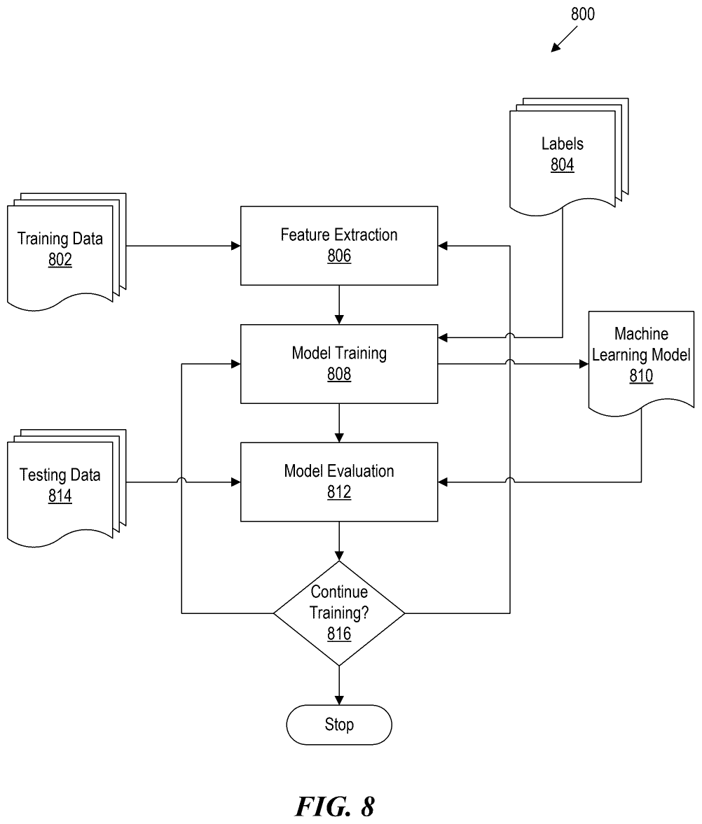

FIG. 8 is a block diagram that illustrates an example process for training a machine learning model, such as the machine learning model 602 illustrated in FIG. 6. The process 800 can be performed on a computing system. The process 800 is merely an example, and actual training processes may have more or fewer operations or perform operations in a different order, as will be readily appreciated by those of skill in the art. For example, in some implementations, a training process can include a separate tuning dataset that can be used for tuning model parameters.

At operation 806, the computing system can extract features from training data 802. In some implementations, feature extraction can include data preprocessing, for example to drop unneeded data, to conform data to standardized formats, to encode data in formats suited to use in machine learning, and so forth. The training data can include atmospheric data, KPI data, RIM data, cell site configuration data, or any combination thereof (as discussed above in reference to FIG. 6). At operation 808, the computing system can train the model using the extracted features and labels 804. The labels 804 can indicate, for example, whether or not a tropospheric ducting event occurred. Training the model can include adjusting one or more weights or parameters. Training can output a machine learning model 810. At operation 812, the computing system can evaluate the machine learning model 810, for example to determine if it meets a threshold accuracy rate, repeatability rate, and so forth, using testing data 814. At operation 816, the computing system can determine whether or not to continue training. If further training is to be performed, the process can proceed to either operation 806 or to operation 808. If the process 800 proceeds to operation 806, additional and/or different extracted features can be selected for model training. If the process 800 proceeds to operation 808, the computing system can continue model training using the same extracted features. If the system determines that training is not to continue, the process can stop.

There are various practical considerations when using a machine learning model to predict tropospheric ducting events and/or to predict remote interference events. Cell sites can be spread throughout a large area (e.g., the United States has an area of about 9.8 million kilometers and the contiguous US spans about 25 degrees of latitude and about 58 degrees of longitude). The National Oceanic and Atmospheric Administration currently offers weather data with as low as 0.25 degree resolution. In some cases, forecast data can be available on an hourly, eight times per day, four times per day, or other schedule, and can be forecast several days into the future.

To achieve feasible training times and fast model performance, it can be significant to trim down available data. For example, rather than considering the weather data at every data point provided by NOAA (or another organization that provides weather data), larger areas can be formed. For example, a larger area can be defined, and the weather data associated with that area can be an average of the data points inside the area. In some implementations, larger areas can be hexagons. In some implementations, areas can be uniform. In some implementations, areas can vary in size. For example, larger areas can be used where weather is more consistent (e.g., in inland areas far from large bodies of water) and can be smaller in areas with large variations in climate. For example, a relatively large region of a state such as Virginia away from the coast can have little variation in weather conditions. However, an area such as the San Francisco Bay Area, which is located near large bodies of water and has diverse topography, can have dramatic differences in weather conditions over readily walkable distances. Daily variations in weather conditions can also differ in different areas. For example, some areas can have fairly stable weather conditions that change little or are highly predictable, while other areas can see significant changes in weather conditions from day to day, and forecasts can be less reliable.

In some implementations, climate variation (e.g., change over distance), weather stability (e.g., change over time), or both can be used to define areas, to determine a frequency of forecast data (e.g., every hour, three hours, six hours, day, etc.), to determine a length of forecast data (e.g., one day, two days, one week, etc.), to determine how often a model should be run for a given area, and so forth. For example, an area with little variation and stable weather can use larger areas and tropospheric ducting events can be reliably predicted further into the future. Thus, for such areas, a model can be run less frequently. In comparison, an area with rapid changes in weather can be difficult to predict and tropospheric ducting forecasts can be made less far into the future. When predicting tropospheric ducting events for such areas, the frequency of forecast data can be higher (e.g., shorter times between forecast data points) than for areas with comparatively stable weather. In some implementations, tropospheric ducting events may be predicted less far into the future in areas with rapid and/or unpredictable weather changes.

In some implementations, the location of cell sites can be used in determining the size of an area. In some implementations, the density of cell sites can be used in determining the size of an area. For example, in remote areas with few or no cell sites, an area size can be greater. In some implementations, such areas can be omitted entirely.

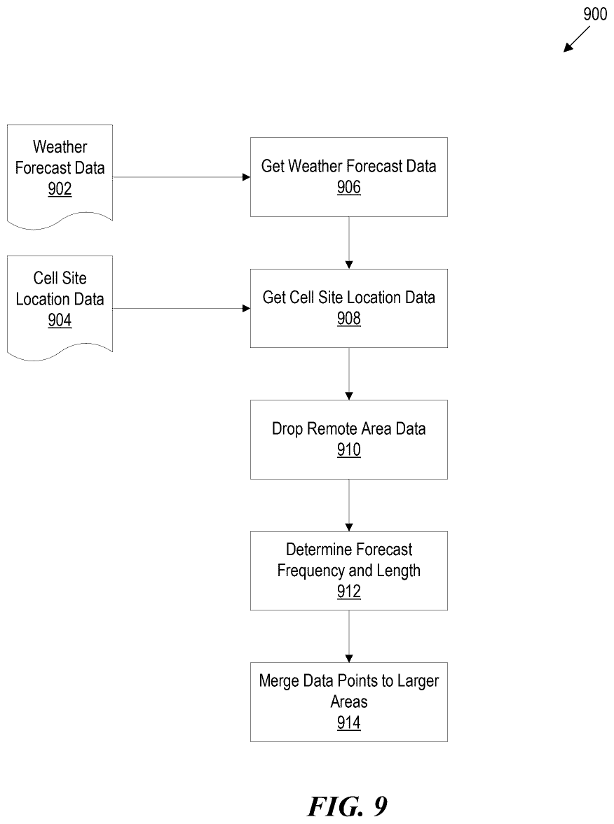

FIG. 9 illustrates an example process for defining geographic areas and trimming data. The process 900 can be executed on a computing system. At operation 906, the computing system can retrieve weather forecast data 902, for example by using an application programming interface (API) to access a third party source of weather forecast data (e.g., NOAA). At operation 908, the computing system can retrieve cell site location data 904. At operation 910, the computing system can drop weather forecast data for remote areas where there are few or no cell site locations. At operation 912, the system can determine forecast frequency and length, for example based on historical weather stability. At operation 914, the computing system can merge data points to form larger areas. As discussed above, in some implementations, each area can be the same size. In some implementations, areas can have different sizes.

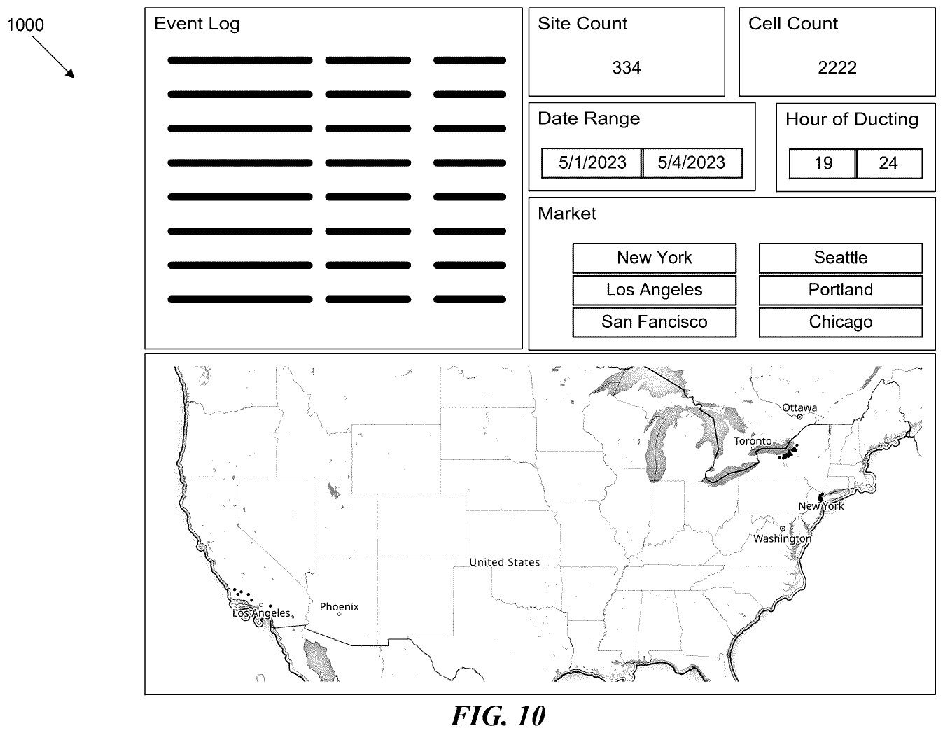

FIG. 10 illustrates an example user interface that can be used to display tropoducting information. The interface 1000 can include an event log, site count, cell count, date range selection, hour range selection, market selection, and map. The map can show the location of tropoducting events. In the example of FIG. 10, the map shows tropoducting events in southern California, upstate New York, and near New York City, as indicated by the black circles. The event log can show details of tropoducting events, such as the involved site and/or cell, time of the event, and other event information. The site count can show a number of impacted sites. The cell count can show a number of impacted cells. The date range selection can include inputs for specifying a starting date and an ending date. The hour range selection can include inputs for specifying a starting hour and an ending hour. The market selection can enable users to select one or more markets. For example, if a user wants to see tropoducting events in the San Francisco market, the user can select San Francisco from the market selection. The user interface can update in response to a change in the date range selection, hour range selection, and/or market selection. For example, the map and/or event log can update to show only events within the selected date range, hour range, and/or market(s).

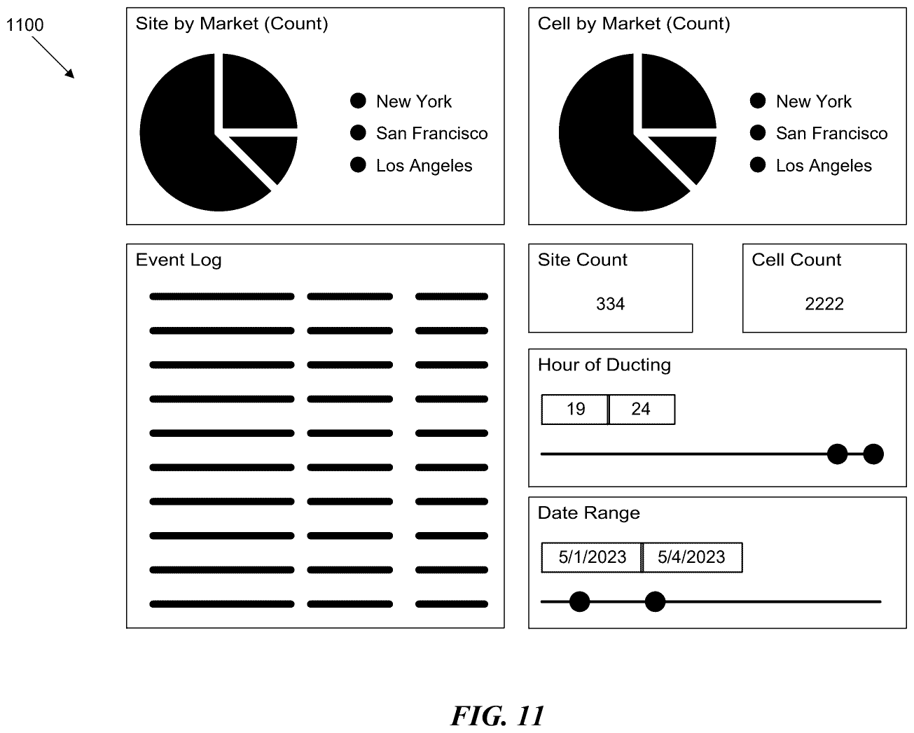

FIG. 11 illustrates another example user interface that can be used to display tropoducting information. The interface 1100 can include a pie chart or other graphical representation showing the number of sites impacted by tropoducting within a market. The interface 1100 can include a second pie chart or other graphical representation showing the number of cells impacted by tropoducting within a market. The event log can display detailed information about tropoducting events. For example, the event log can show the same or similar information as the event log illustrated in FIG. 10. Similar to the interface 1000 of FIG. 10, the interface 1100 can include a site count showing the number of impacted sites, a cell count showing the number of impacted cells, a date range selection, and/or an hour range selection. In some implementations, the date range selection and/or the hour range selection can include input boxes and/or sliders for selecting starting times, ending times, starting dates, and/or ending dates.

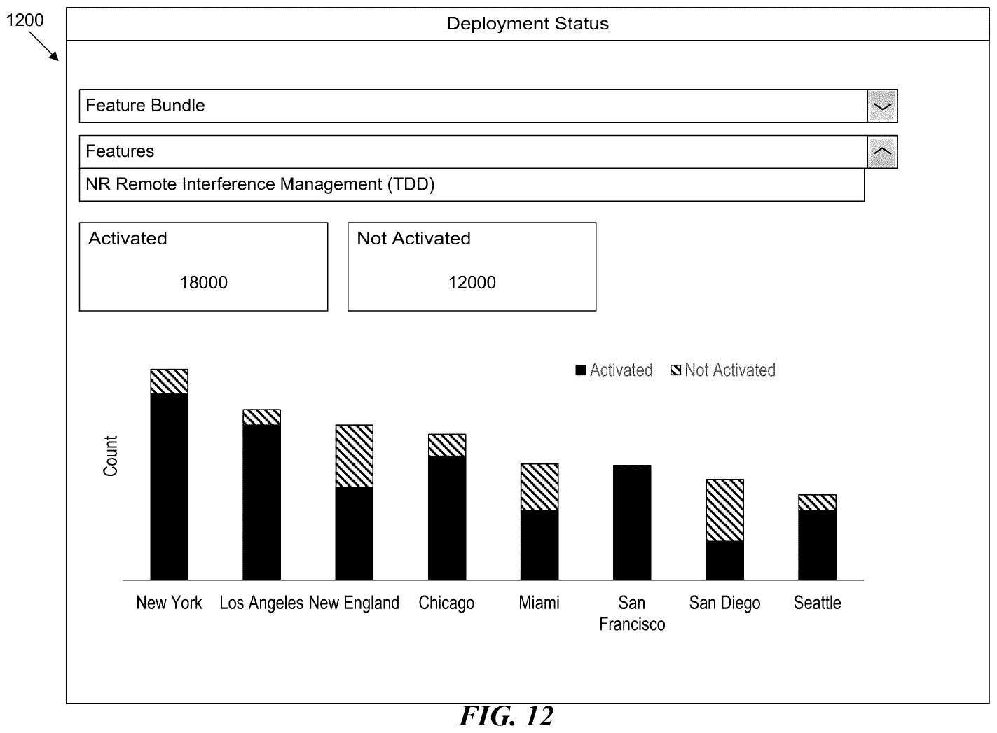

FIG. 12 illustrates another example user interface that can be used to check the deployment status of features at cell sites according to some implementations, for example features that can be used to mitigate tropospheric ducting (also referred to as remote interference). The interface 1200 can include a dropdown menu for selecting a feature bundle. The feature bundle can include one or more features. For example, related features, such as those for mitigating tropoducting, can be bundled into feature bundle. The interface 1200 can include a second dropdown for selecting one or more features of a selected feature bundle. In the example of FIG. 12, the interface shows a remote interference management feature. The interface 1200 can include a summary showing the number of cells and/or number of sites with the feature activated and/or the number of cells and/or sites that do not have the feature activated. The interface 1200 can include a bar chart or other graphical representation showing the status of feature activation in various markets, regions, etc.

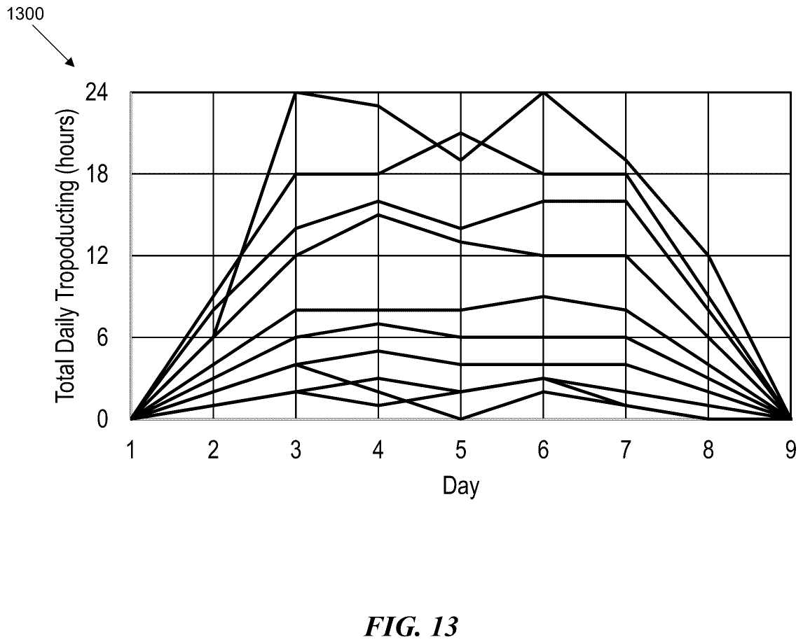

FIG. 13 shows an example plot of total daily tropoducting. The plot 1300 shows multiple cells and/or nodes. The vertical axis indicates the total number of hours that each cell and/or node experienced tropoducting, while the horizontal axis indicates the day. Similar plots can be made at higher or lower levels of granularity. For example, a plot could be total hourly tropoducting in minutes as a function of hour, or total number of days of tropoducting as a function of week.

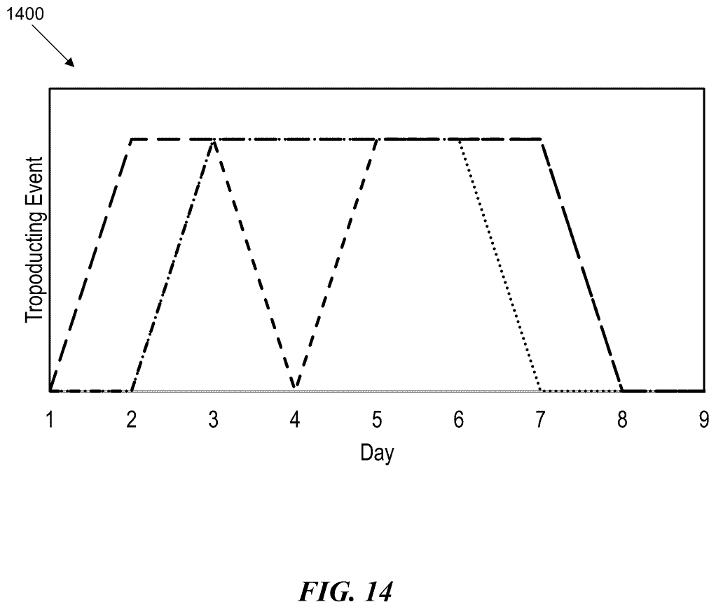

FIG. 14 shows an example plot of daily tropoducting. The plot 1400 shows multiple cells and/or nodes. The vertical axis indicates whether or not a tropoducting event was observed on a particular day at a particular cell and/or node. For example, the value can be 1 if a tropoducting event was observed and 0 if a tropoducting event was not observed.

### Computer System

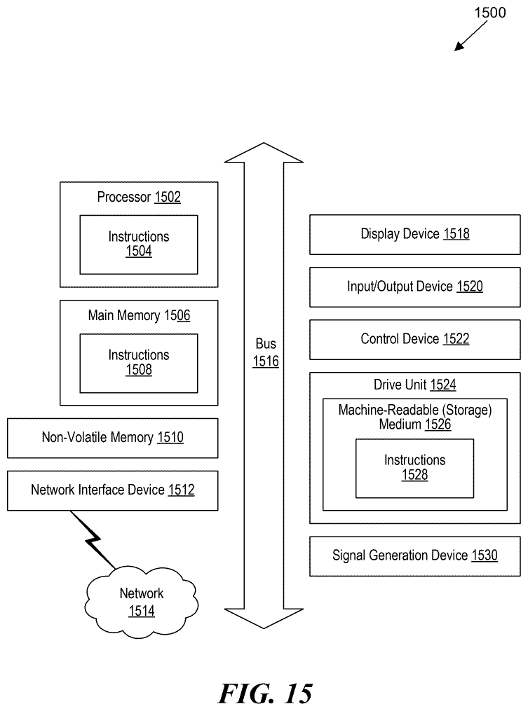

FIG. 15 is a block diagram that illustrates an example of a computer system 1500 in which at least some operations described herein can be implemented. As shown, the computer system 1500 can include: one or more processors 1502, main memory 1506, non-volatile memory 1510, a network interface device 1512, a video display device 1518, an input/output device 1520, a control device 1522 (e.g., keyboard and pointing device), a drive unit 1524 that includes a machine-readable (storage) medium 1526, and a signal generation device 1530 that are communicatively connected to a bus 1516. The bus 1516 represents one or more physical buses and/or point-to-point connections that are connected by appropriate bridges, adapters, or controllers. Various common components (e.g., cache memory) are omitted from FIG. 15 for brevity. Instead, the computer system 1500 is intended to illustrate a hardware device on which components illustrated or described relative to the examples of the figures and any other components described in this specification can be implemented.

The computer system 1500 can take any suitable physical form. For example, the computing system 1500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1500. In some implementations, the computer system 1500 can be an embedded computer system, a system-on-chip (SOC), a single-board computer system (SBC), or a distributed system such as a mesh of computer systems, or it can include one or more cloud components in one or more networks. Where appropriate, one or more computer systems 1500 can perform operations in real time, in near real time, or in batch mode.

The network interface device 1512 enables the computing system 1500 to mediate data in a network 1514 with an entity that is external to the computing system 1500 through any communication protocol supported by the computing system 1500 and the external entity. Examples of the network interface device 1512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1506, non-volatile memory 1510, machine-readable medium 1526) can be local, remote, or distributed. Although shown as a single medium, the machine-readable medium 1526 can include multiple media (e.g., a centralized/distributed database and/or associated caches and servers) that store one or more sets of instructions 1528. The machine-readable medium 1526 can include any medium that is capable of storing, encoding, or carrying a set of instructions for execution by the computing system 1500. The machine-readable medium 1526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1504, 1508, 1528) set at various times in various memory and storage devices in computing device(s). When read and executed by the processor 1502, the instruction(s) cause the computing system 1500 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for predicting and mitigating tropospheric ducting events in a wireless telecommunications network, the method comprising:
receiving atmospheric data comprising atmospheric parameters from one or more data sources;
receiving current cell site configuration data of one or more cell sites of the wireless telecommunications network from one or more second data sources;
applying a trained machine learning model to the atmospheric data and the current cell site configuration data to predict one or more tropospheric ducting events,
wherein the machine learning model is trained using supervised learning, and
wherein the supervised learning is performed using historical atmospheric data and historical cell site configuration data as inputs and historical tropospheric ducting events of the wireless telecommunications network as outputs;
determining, based on an output of the machine learning model, a likelihood of a tropospheric ducting event affecting a cell site among the one or more cell sites of the wireless telecommunications network in a geographic area;
determining at least one mitigation action to perform at the cell site,
wherein implementing the at least one mitigation action at the cell site effectuates reduction in an impact of the predicted one or more tropospheric ducting events at the cell site.

2. The method of claim 1, further comprising:
determining a predicted duration of the tropospheric ducting event.

3. The method of claim 2, wherein determining the at least one mitigation action is based at least in part on the predicted duration of the tropospheric ducting event and the received current cell site configuration data for the cell site.

4. The method of claim 3, wherein determining the at least one mitigation action reduces a number of antenna downtilt adjustments for a plurality of cell sites, and wherein reducing the number of antenna downtilt adjustments for the plurality of cell sites reduces greenhouse gas emissions by reducing a number of miles driven by a vehicle to perform the antenna downtilt adjustments.

5. The method of claim 3, wherein the least one mitigation action comprises: changing an uplink power control parameter, forcing handover to a healthy neighbor cell site, changing an antenna downtilt, increasing a time domain duplexing guard period, switching an uplink user plane, or preventing user equipment from remaining in idle mode on the cell site.

6. The method of claim 1, wherein the atmospheric data comprises forecast data, wherein preprocessing the atmospheric data comprises:
determining, for a plurality of cell site locations, a weather stability at each cell site location;
determining, based on the weather stability, a forecast frequency for each cell site location;
determining, based on the weather stability, a forecast duration for each cell site location; and
trimming the atmospheric data based on the determining forecast frequency and the determined forecast duration for each cell site location.

7. A method for training a machine learning model to predict tropospheric ducting events comprising:
receiving training data comprising historical atmospheric data and historical network performance data;
preprocessing the training data, wherein the preprocessing comprises at least one of: dropping a portion of the training data or modifying one or more attributes of the training data to conform to a standardized format;
extracting features from the training data;
generating labels for the training data, wherein the labels indicate whether or not a tropospheric ducting event occurred; and
training the machine learning model,
wherein training is performed using supervised learning, wherein the supervised learning uses the extracted features as inputs and the generated labels as outputs,
wherein the machine learning model is configured to determine a likelihood of a tropospheric ducting event.

8. The method of claim 7, wherein the training data further comprises historical cell site configuration data, wherein the machine learning model is additionally trained using at least one feature extracted from the historical cell site configuration data.

9. The method of claim 7, wherein the historical atmospheric data comprises at least one of refractive index or a combination of humidity, air pressure, and atmospheric pressure.

10. The method of claim 7, wherein historical tropospheric ducting events are determined based on a slope of remote interference power over time.

11. The method of claim 7, wherein historical tropospheric ducting events are determined based on physical uplink shared channel (PUSCH) received interference power and uplink symbol interference plus noise delta.

12. The method of claim 7, wherein the machine learning model is additionally training using cell site configuration data.

13. The method of claim 12, further comprising:
determining one or more cell site configuration changes to mitigate a predicted tropospheric ducting event.

14. The method of claim 7, wherein preprocessing the training data comprises:
determining, based on at least one of cell site density and weather stability, a size of a geographic area unit; and
averaging historical atmospheric data inside the geographic area unit.

15. A system for predicting and mitigating tropospheric ducting events in a wireless telecommunications network using a machine learning model, the system comprising:
at least one hardware processor;
at least one non-transitory memory storing instructions executable by the at least one hardware processor;
a data collection module configured to:
receive atmospheric data comprising atmospheric parameters from one or more data sources;
receive current cell site configuration data of one or more cell sites of the wireless telecommunications network from one or more second data sources;
a tropospheric ducting prediction module configured to:
apply the machine learning model to the atmospheric data and the current cell site configuration data to predict one or more tropospheric ducting events, wherein the machine learning model is trained using supervised learning, wherein the supervised learning is performed using historical atmospheric data and historical cell site configuration data as inputs and historical tropospheric ducting events of the wireless telecommunications network as outputs;
determine, based on an output of the machine learning model, a likelihood of a tropospheric ducting event affecting a cell site among the one or more cell sites of the wireless telecommunications network in a geographic area;
determine at least one mitigation action to perform at the cell site; and
provide the at least one mitigation action to a user,
wherein implementing the at least one mitigation action at the cell site effectuates reduction in an impact of the predicted one or more tropospheric ducting events at the cell site.

16. The system of claim 15, wherein the tropospheric ducting prediction model is further configured to predict a duration of the tropospheric ducting event.

17. The system of claim 16, wherein determining the at least one mitigation action is based at least in part on the predicted duration of the tropospheric ducting event and the cell site configuration data.

18. The system of claim 17, wherein the at least one mitigation action comprises adjusting an antenna downtilt, wherein determining the at least one mitigation action reduces a number of antenna downtilt adjustments for a plurality of cell sites, wherein reducing the number of antenna downtilt adjustments for the plurality of cell sites reduces greenhouse gas emissions by reducing a number of miles driven by a vehicle to perform the antenna downtilt adjustments.

19. The system of claim 17, wherein the least one mitigation action comprises changing an uplink power control parameter, forcing handover to a healthy neighbor cell site, changing an antenna tilt, increasing a time domain duplexing guard period, switching an uplink user plane, or preventing user equipment from remaining in idle mode on the cell site.

20. The system of claim 15, wherein the atmospheric data comprises forecast data, wherein preprocessing the atmospheric data comprises:
determining, for a plurality of cell site locations, a weather stability at each cell site location;
determining, based on the weather stability, a forecast frequency for each cell site location;
determining, based on the weather stability, a forecast duration for each cell site location; and
trimming the atmospheric data based on the determining forecast frequency and the determined forecast duration for each cell site location.
